(19) United States
(12) Patent Application Publication
(10) Pub. No.: US 2014/0230689 A1
(43) Pub. Date: Aug. 21, 2014

(54) VEGETABLE OIL-BASED METAL RESINATE COMPOSITIONS AND MATERIALS COMPRISING SAME

(71) Applicant: MEADWESTVACO CORPORATION, Richmond, VA (US)

(72) Inventors: Richard C. Houser, DeRidder, LA (US); Gregory Webb, Daniel Island, SC (US)

(21) Appl. No.: 14/240,924

(22) PCT Filed: Aug. 6, 2012
(86) PCT No.: PCT/US12/49726

§ 371 Date: Feb. 25, 2014

Related U.S. Application Data
(60) Provisional application No. 61/548,294, filed on Oct. 18, 2011.
(60) Provisional application No. 61/527,338, filed on Aug. 25, 2011.

(51) Int. Cl. C09D 11/06

(52) U.S. Cl. CPC C09D 11/06
USPC 106/31.13

(57) ABSTRACT

A vegetable oil-based resinous composition comprises a metallization product of vegetable oil-based adduct, wherein the vegetable oil includes at least one unsaturated double bond. The vegetable oil-based adducts may include a Diels-Alder adduct, a ene reaction adduct, or combinations thereof. The metallizing agent may be selected based on various factors such as the types of substrates, the techniques of applying the composition to the substrate, and the end use applications of the composition. The resinous composition may be used as an alternative to a conventional rosin-based resinate binder for various end use applications such as printing inks, coatings, and adhesives on a variety of substrates.

### BACKGROUND OF THE DISCLOSURE

Printing ink typically consists of colorant, binder, solvent, and additive. Ink binder binds other ingredients of the ink together so that the ink may form a film and adhere to the surface being printed. The binder also imparts desired physical properties to the ink. Solvent controls viscosity, rheology and transferability of the ink to the surface being printed. Various additives have been used to enhance ink performance for selected end use applications.

Rosin-based resins have been widely used as binders for printing inks for many years. These resins may be derived from tall oil rosin, wood rosin, gum rosin, or combinations thereof. U.S. Pat. Nos. 2,299,135; 2,393,637; and 4,398,016 disclose rosin-modified phenolic resins for offset printing inks.

Rosin-based resins have been extensively used for the preparation of metal resonates, which are commonly used as binders in gravure printing inks because of their rapid solvent release. Rosin-based compounds, such as phenolated rosin, polymerized rosin, maleated rosin, or fumarized rosin, are subjected to a metallization to generate rosin-based metal resinates. U.S. Pat. No. 5,082,497 discloses a gravure printing ink comprising a rosin-based resinate binder, pigment, and hydrocarbon solvent.

A critical property of ink formulations that is directly linked to viscosity is dilutability. Viscosity is measured by the time required for an exact quantity of solution to flow by gravity through a specially sized apparatus. Dilutability is measured by the amount of solvent needed to reduce the viscosity of a given weight of resinate solution to a certain level. The common dilutability values of commercial resinates are between 70 ml to 120 ml, which means that about 70 ml to 120 ml of solvent (typically toluene) are needed to reduce the resinate viscosity such that 100 grams of resinate passes through a #2 Shell cup in 18 seconds. Resinates with high dilutability values are desirable, since they require additional solvent to bring the ink to a desired viscosity. They permit the production of more economical inks because solvent is a relatively inexpensive component in ink formulations. Several methods have been reported to address the viscosity and dilutability problems of the rosin-based metal resinates for gravure printing inks. U.S. Pat. No. 2,610,180 discloses the use of a small amount of ethylcellulose or ethylhydroxy ethylcellulose as a dilution enhancer in the ink formulation. U.S. Pat. No. 5,512,622 discloses the use of a dilution-enhancing polymer selected from the group consisting of polymers of maleic anhydride and ethylene, and polymers of acrylonitrile, butadiene, acrylic acid or methacrylic acid.

Unfortunately, rosins are often subjected to a fluctuation in market demands that results in cycles of supply overload or shortage. Furthermore, the supply of rosins such as gum rosin is limited to their harvest availability. Therefore, industries may face a global shortage of rosin raw materials. Furthermore, the price of rosins may be unpredictably too excessive for an economically production of rosin-based metal resinates.

Accordingly, it is desirable to have metal resinate binders derived from alternative sources to rosins that provide similar printing ink performance as those made from rosin-based resinates. Examples of the ink performance affected by the binder used to formulate printing inks are gloss, drying properties, blocking, holdout, film formation, film toughness (i.e., resistance to abrasion), reducibility, printability, color development, resistance to static movement or rub, compatibility and stability.

U.S. Pat. No. 6,020,401 discloses the use of acrylic resins as binders for solvent-based gravure printing inks. The acrylic resins are prepared from acrylic-based monomers derived from a petroleum-based raw material. Thus, the price and availability of acrylic-based monomers are tightly linked to those of petroleum oil which are volatile in current market conditions.

Vegetable oils are natural oils found in plants. Vegetable oil consists of a glycerol and fatty acids attached to the glycerol backbone. U.S. Pat. No. 6,762,216 discloses a printing ink composition using vegetable oil as an ink solvent and a rosin-modified phenol resinous as an ink binder. U.S. Pat. No. 5,122,188 discloses lithographic printing inks comprising pigments and a substantially non-oxidized vegetable oil heated to within a specified viscosity range. However, the use of vegetable oil-based inks for lithographic printing presses have been limited due to lengthy ink drying time, environmental waste concerns, high production cost, high material cost, and difficulty in clean up.

### SUMMARY OF THE DISCLOSURE

A vegetable oil-based resinous composition comprises a metallization product of vegetable oil-based adduct, wherein the vegetable oil includes at least one unsaturated double bond. The vegetable oil-based adducts may include Diels-Alder adduct, ene reaction adduct, or combinations thereof. The metallizing agent may be selected based on various factors such as the types of substrates, the techniques of applying the composition to the substrate, and the end use applications of the composition. The resinous composition may be used as an alternative to a conventional rosin-based resinate binder for various end use applications such as printing inks, coatings, and adhesives on a variety of substrates.

### DETAILED DESCRIPTION OF THE DISCLOSURE

The present disclosures now will be described more fully hereinafter, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements.

A particular embodiment of the disclosed vegetable oil-based resinous composition may comprise a metallization product of vegetable oil-based adduct and a metallization agent, wherein the vegetable oil includes at least one unsaturated double bond. The vegetable oil-based adduct may include Diels-Alder adduct, ene reaction adduct, or combinations thereof. The adduct may comprise a dienophile and a vegetable oil including at least one unsaturated double bond. Optionally, the adduct may further comprise an adduct facilitating agent.

The vegetable oils may be derived from various plant sources including, but not limited to, linseed oil, soybean oil, cottonseed oil, sunflower oil, safflower oil, corn oil, sesame oil, canola oil, rapeseed oil, peanut oil, tung oil, castor oil, oiticica oil, perilla oil, hempseed oil, poppyseed oil, and mixtures thereof. The vegetable oil may include at least one conjugated double bond.

The vegetable oils suitable for use in the present disclosure may be non-modified vegetable oils or alternatively modified vegetable oils. Examples of suitable modified vegetable oils may include, but not limited to, blown vegetable oil, polymerized vegetable oil, hydrogenated vegetable oil, epoxidized vegetable oil, disproportionated vegetable oil, or mixtures thereof.

Various dienophiles may be used in the present disclosure including, but not limited to, unsaturated dicarboxylic acids such as fumaric acid, maleic acid, citraconic acid, itaconic acid; α, β-unsaturated compounds such as acrylic acid and methacrylic acid; and mixtures thereof. In one embodiment, the dienophile may be maleic anhydride.

The metals used for the metallization agent may be selected based on various factors including, but not limited to, the types of substrates on which the disclosed resinous composition will be applied, the techniques employed to apply the composition to the substrate, and the end use applications of the composition. Suitable metallization agents may include, but are not limited to, those derived from a metal selected from the group consisting of zinc, calcium, magnesium, sodium, potassium, lithium, ammonium salt, copper, silver, and combinations thereof. Non-limiting examples of metallization agents may include, but are not limited to, calcium hydroxide, magnesium oxide, zinc oxide, and combinations thereof. In one embodiment, the metallization agent may be calcium hydroxide.

In one embodiment, the vegetable oil-based resinous composition may be produced by a method comprising: reacting vegetable oil including at least one unsaturated double bond with at least one dienophile to generate a vegetable oil-based adduct; and treating the vegetable oil-based adduct with a metallization agent.

The disclosed method may further comprise adding an adduct facilitating agent to the vegetable oil prior to reacting the vegetable oil with the dienophile. Non-limiting examples of the adduct facilitating agents may include fatty acid, rosin, styrene, cyclopentadiene or other ene compounds depending on the conditions for Diels-Alder reaction or ene reaction with the selected dienophile. Various fatty acids may be used as the adduct facilitating agents including, but not limited to, fatty acids derived from hydrolysis of the vegetable oil, tall oil fatty acid, tallow fatty acid, or mixtures thereof.

The disclosed vegetable oil-based compositions may be used to prepare various materials suitable for a wide ranges of end use applications including, but not limited to: printing inks; coatings; paints; adhesives such as pressure sensitive adhesives; elastomers; road marking materials; circuit production materials such as for typical printed circuits or RFID printed circuits.

A particular embodiment of the disclosed printing ink may comprise the aforementioned vegetable oil-based resinous composition. In one embodiment, the printing ink may comprise the disclosed vegetable oil-based resinous binder, a colorant dispersed in the resinous binder, and a solvent. The disclosed resinous compositions may be used at least partially as substitutions for rosin-based binders while providing the ink performance similar to those of known inks obtained from rosin-based binders.

An amount of the vegetable oil-based resinous composition in the printing inks may vary widely, depending upon several factors such as the desired viscosity of the printing ink, the properties of the colorants, and the types of printing press.

Any colorants capable of imparting the desired color and printing characteristics may be used in the present disclosure. The colorants may be inorganic pigments, organic pigments, dyes, or mixtures thereof. Examples of suitable pigments may include, but are not limited to, powdered pigment or pigment dispersion.

A variety of solvents known for printing ink formulations may be used including, but not limited to, aliphatic hydrocarbons, aromatic hydrocarbons, naphthenics, paraffinics, isoparaffinics and mixtures thereof. Examples of suitable hydrocarbon solvents may include, but are not limited to, toluene, naptha, lactol spirit, xylene, and mixtures thereof. Ink oils including aliphatic hydrocarbon solvents may be used. Non-limiting examples of ink oils may include MAGIESOL™ 47 and MAGIESOL™ 52 ink oils commercially available from Calumet Specialty Products Partners, L.P. (Indianapolis, Ind.). An amount of solvent in the printing ink formulation may be varied, depending upon various factors such as the types of hydrocarbon solvents, the types of pigments, the types of ink binders, the desired viscosity, the printing speed, and combinations thereof. High speed gravure printing applications typically use solvent, such as toluene or reclaimed toluene, to modify the ink viscosity for transfer from a printing press to a substrate.

Where desired, the disclosed printing ink may include other resinates commonly used for formulation of printing inks. The additional resinates may be rosin-based resinates. For example, the additional resinates may be produced by a metallization of rosin-based compounds selected from the group consisting of phenolated rosin, polymerized rosin, maleated rosin, fumarized rosin, and combinations thereof.

The disclosed printing ink may further comprise an effective amount of additives and other auxiliary components to enhance ink performance or ink processability. Examples of such additives may include, but are not limited to, reinforcing fillers, rheological modifiers, plasticizers, stabilizers, drying agents, lubricants, antioxidants, surface-active agents, preservatives, and mixtures thereof.

The disclosed vegetable oil-based resinous composition may be used in solvent-based gravure printing ink as at least a partial substitution of rosin-based resinous binder. The disclosed gravure printing ink may exhibit similar performance as the inks made from the rosin-based resinous binders. The disclosed gravure printing inks may also offer several benefits over the conventional inks made from the rosin-based resinous binder. Rosins have high melt points; therefore, a substantial amount of heat is required to reduce the viscosity of the rosins and facilitate the handling. In comparison, vegetable oils have lower viscosity and do not require the same amount of heat energy. Furthermore, the viscosity of the disclosed inks is lower than that of the conventional inks made from rosin-based resinous binder at the same toluene dilution ratio.

The disclosed vegetable oil-based composition may be used as a grinding material to coat pigment particles for inks or coatings applications. When desired, the disclosed vegetable oil-based composition may be used as a letdown material to reduce the amount of pigment bases typically needed in inks or coatings applications. Furthermore, the disclosed vegetable oil-based composition may be used as a substitution of wax or elastic component in the formulations of inks, coatings or adhesives.

### EXAMPLES

The following examples are provided to further illustrate the present disclosure; they are not to be construed as limiting the disclosure in any manner

### Example 1

About 550 grams of linseed oil was heated to a temperature of 205° C. and then added with about 85 grams of maleic anhydride. The mixture was allowed to react for about 3 hours to produce a Diels-Alder or ene adduct of linseed oil and maleic anhydride. About 16 grams of water was then added as the reacted mixture was cooled down to below 100° C. About 300 grams of toluene was added as the reacted mixture was cooling to below 100° C. At a temperature of about 95° C., slurry consisting of about 25 grams of calcium hydroxide and about 155 grams of toluene was added and the mixture was allowed to mix for about 30 minutes. Then, the mixture was heated to a temperature of to 117° C. to decant water evolved from the reaction of calcium hydroxide and a linseed oil adduct.

### Example 2

About 550 grams of linseed oil was heated to a temperature of 205° C. and then added with about 85 grams of maleic anhydride. The mixture was allowed to react for about 2.5 hours to produce a Diels-Alder or ene adduct of linseed oil and maleic anhydride. About 16 grams of water was then added as the reacted mixture was cooled down to below 100° C. About 400 grams of toluene was added as the reacted mixture was cooling to below 100° C. At a temperature of about 95° C., slurry consisting of about 22 grams of calcium hydroxide and about 150 grams of toluene was added and the mixture was allowed to mix for about 30 minutes. Then, the mixture was heated to a temperature of 117° C. to decant water evolved from the reaction of calcium hydroxide and linseed oil adduct.

### Example 3

About 715 grams of linseed oil was heated to a temperature of 205° C. and then added with about 110.5 grams of maleic anhydride. The mixture was allowed to react for about 2.5 hours to produce a Diels-Alder or ene adduct of linseed oil and maleic anhydride. About 20 grams of water was then added as the reacted mixture was cooled down to below 100° C. About 545 grams of toluene was added as the reacted mixture was cooling to below 100° C. At a temperature of about 95° C., slurry consisting of about 39 grams of calcium hydroxide and about 210 grams of toluene was added and the mixture was allowed to mix for about 30 minutes. Then, the mixture was heated to a temperature of 117° C. to decant water evolved from the reaction of calcium hydroxide and linseed oil adduct.

Testing of the Resinous Binders

The resinous binders of EXAMPLES 1, 2, and 3 were tested for the toluene dilution property, % solids, viscosity, and melting points. The test results were as shown in TABLE 1.

Dilution of the resinous binder was determined as the volume in ml of toluene/100 g of resin sample needed to reduce the sample's viscosity to 18 seconds on a #2 Shell cup according to ASTM Method D4212-88, Viscosity by Dip-type Viscosity Cups.

Viscosity of the resinous binder was measured according to ASTM Method D1545 (Gardner-Holdt-Bubble Time Method) using Gardner bubble tube.

Melting point of the resinous binder was measured using solids capillary method, which is well known to one of ordinary skill in the art.

TABLE 1

| | EXAMPLE 1 | EXAMPLE 2 | EXAMPLE 3 |
|---|---|---|---|
| Toluene Dilution¹ | 160 ml/100 g | 100 ml/100 g | 84 ml/100 g |
| to about 18 seconds, | | | |
| #2 Shell cup | | | |
| Viscosity² | too viscous | V− | I+ |
| (Gardner Bubble | to gelatinous | | |
| Tube) | | | |
| % Solids | 59.2% | 54.5% | 53.6% |
| Melting Point³ | >200° C. | >200° C. | >200° C. |

¹ASTM Method D4212-88
²ASTM Method D1545
³Solids Capillary Method

It is understood that the test results shown in TABLE 1 are mere examples of some embodiments of the presently disclosed resinous binders. One of ordinary skill in the art understands that the properties of the disclosed resinous binders may be varied according to various factors including, but not limited to, the production conditions, the types and relative amounts of each component used for the preparation of the resinous binders.

Preparation of Printing Inks

A solvent-based ink was prepared using the vegetable oil-based resinate of EXAMPLE 2 as a binder, toluene as a solvent, and the publication gravure magenta as a pigment. The ink made from the vegetable oil-based resinate of EXAMPLE 2 was tested for ink performance and compared to those of similar ink made from rosin-based resinate.

Printing Ink Containing the Vegetable Oil-Based Resinate of EXAMPLE 2

About 16 grams of publication gravure magenta base/pigment was added to about 25 grams of the vegetable oil-based resinate of EXAMPLE 2. About 16 grams of toluene was added, and the mixture was mixed to produce a printing ink. Then, the viscosity of the ink was adjusted to below 18 seconds flowing through #2 Shell cup. About 24 ml of toluene was added to achieve the printing ink with a viscosity of 16.9 seconds.

Conventional Printing Ink Containing Rosin-Based Resinate

For test comparison, the conventional printing ink was produced using rosin-based resinate as a binder. A rosin-based resinate JONREZ® MR-635 commercially available from MeadWestvaco Corporation was used as an ink binder. About 16 ml of toluene were added to achieve the printing ink with the viscosity of 16.7 seconds.

Printing Ink Performance

Printing ink was drawn down using a #7 Meyer bar on 40 lb-coated paperstock. The properties of the paper coated with the disclosed ink (based on EXAMPLE 2 binder) was tested and compared to those of the paper coated with the conventional ink.

The disclosed ink transferred well and appeared to lay smoother on the paper substrate compared to the conventional ink. The disclosed ink showed a density of 2.15 g/ml and a 60 degree gloss reading of 35.3; while the conventional ink had a density of 2.28 g/ml and a 60 degree gloss reading of 40.2.

The block testing was performed at 154° F. using 50 lbs pressure for 15 seconds. The conventional ink showed good ink-to-substrate contact release, as well as good ink-to-ink contact release. The disclosed ink exhibited a similar level of ink-to-substrate contact release as that of the conventional ink. The ink-to-ink contact release of the disclosed ink was slight lower than that of the conventional ink.

It is to be understood that the foregoing description relates to embodiments are exemplary and explanatory only and are not restrictive of the disclosure. Any changes and modifications may be made therein as will be apparent to those skilled in the art. Such variations are to be considered within the scope of the disclosure as defined in the following claims.

1. A vegetable oil-based resinous printing ink composition, comprising a metallization product of a vegetable oil-based adduct and a metallization agent, wherein:
the vegetable oil includes at least one unsaturated double bond; and
the vegetable oil-based adduct includes a Diels-Alder adduct, an ene reaction adduct, or a mixture thereof of the vegetable oil and a dienophile.

2. The printing ink composition of claim 1, wherein the vegetable oil includes an oil selected from the group consisting of linseed oil, soybean oil, cottonseed oil, sunflower oil, safflower oil, corn oil, sesame oil, canola oil, rapeseed oil, peanut oil, tung oil, castor oil, oiticica oil, perilla oil, hempseed oil, poppyseed oil, and mixtures thereof.

3. The printing ink composition of claim 1, wherein the vegetable oil comprises a modified vegetable oil.

4. The printing ink composition of claim 3, wherein the modified vegetable oil includes a member selected from the group consisting of blown vegetable oil, polymerized vegetable oil, hydrogenated vegetable oil, epoxidized vegetable oil, disproportioned vegetable oil, and mixtures thereof.

5. The printing ink composition of claim 1, wherein the vegetable oil-based adduct comprises a dienophile selected from the group consisting of maleic anhydride, fumaric anhydride, fumaric acid, maleic acid, citraconic acid, itaconic acid, acrylic acid, methacrylic acid, and mixtures thereof.

6. The printing ink composition of claim 1, wherein the vegetable oil-based adduct comprises the vegetable oil, a dienophile, and an adduct facilitating agent.

7. The printing ink composition of claim 6, wherein the adduct facilitating agent includes a member selected from the group consisting of fatty acid, rosin, styrene, cyclopentadiene, and combinations thereof.

8. The printing ink composition of claim 7, wherein the fatty acid includes a member selected from the group consisting of tall oil fatty acid, tallow fatty acid, fatty acid derived from vegetable oil, and combinations thereof.

9. The printing ink composition of claim 1, wherein the metallization agent is derived from a metal including a member selected from the group consisting of zinc, calcium, magnesium, sodium, potassium, lithium, copper, silver, and combinations thereof.

10. The printing ink composition of claim 1, wherein the metallization agent includes a member selected from the group consisting of calcium hydroxide, magnesium oxide, zinc oxide, and combinations thereof.

11. A solvent-based printing ink comprising the vegetable oil-based resinous printing ink composition of claim 1.

12. The solvent-based printing ink of claim 11, comprising the vegetable oil-based resinous printing ink composition of claim 1 as binder, a colorant dispersed in the resinous composition binder, and a solvent.

13. The solvent-based printing ink of claim 12, wherein the solvent includes a member selected from the group consisting of aliphatic hydrocarbons, aromatic hydrocarbons, naphthenics, paraffinics, isoparaffinics and combinations thereof.

14. The solvent-based printing ink of claim 12, further comprising a rosin-based resinate binder.

15. The solvent-based printing ink of claim 12, further comprising an additive selected from the group consisting of reinforcing fillers, rheological modifiers, plasticizers, stabilizers, drying agents, lubricants, antioxidants, surface-active agents, preservatives, and mixtures thereof.

16. The solvent-based printing ink of claim 12, wherein the printing ink is an offset ink, a lithography ink, a screen ink, a letterpress ink, an intaglio ink, a flexography ink, or a gravure ink.

17. The solvent-based printing ink of claim 12, wherein the metallization agent is derived from a metal including a member selected from the group consisting of zinc, calcium, magnesium, sodium, potassium, lithium, copper, silver, and combinations thereof.

18. A vegetable oil-based resinous printing ink composition, comprising:
a vegetable oil-based adduct comprising:
a vegetable oil including at least one unsaturated double bond, and
a dienophile; and
a metallizing agent derived from a metal including a member selected from the group consisting of zinc, calcium, magnesium, sodium, potassium, lithium, copper, silver, and combinations thereof.

19. The printing ink composition of claim 18, wherein the vegetable oil-based adduct includes a member selected from the group consisting of a Diels-Alder adduct, an ene reaction adduct, and a mixture thereof.

20. (canceled)

21. (canceled)

22. (canceled)

23. A solvent-based printing ink comprising the vegetable oil-based resinous composition of claim 18.

24. The solvent-based printing ink of claim 23, comprising the vegetable oil-based resinous composition of claim 18 as binder, a colorant dispersed in the resinous composition binder, and a solvent selected from the group consisting of aliphatic hydrocarbons, aromatic hydrocarbons, naphthenics, paraffinics, isoparaffinics and mixtures thereof.

25. The solvent-based printing ink of claim 23, wherein the metallization agent comprises a member selected from the group consisting of calcium hydroxide, magnesium oxide, zinc oxide, and combinations thereof.
